(19) United States
(12) Patent Application Publication
(10) Pub. No.: US 2022/0314488 A1
(43) Pub. Date: Oct. 6, 2022

(54) METHODS OF FABRICATION OF CERAMIC MIRROR BLANKS

(71) Applicant: CORNING INCORPORATED, CORNING, NY (US)

(72) Inventors: Bethany Rose Conway, Lindley, NY (US); Robin May Force, Corning, NY (US); James Scott Sutherland, Painted Post, NY (US); James William Zimmermann, Corning, NY (US)

(21) Appl. No.: 17/704,087

(22) Filed: Mar. 25, 2022

Related U.S. Application Data
(60) Provisional application No. 63/167,717, filed on Mar. 30, 2021.

(51) Int. Cl. B28B 3/00; C04B 35/626; C04B 35/634; B28B 7/00; B28B 7/10; B28B 1/00

(52) U.S. Cl. CPC B28B 3/003; C04B 35/6268; C04B 35/634; B28B 7/0097; B28B 7/10; B28B 1/004; C04B 2235/602; C04B 2235/668; C04B 2235/775

(57) ABSTRACT

The disclosure relates to methods of fabricating of ceramic structures, and more particularly to methods of fabricating ceramic structures having profiled surfaces and more particularly to methods of fabrication of ceramic mirror blanks. In one embodiment, a method of forming a shaped ceramic article, includes: forming, via one of a cold-pressing process or pressure casting process, a green ceramic article comprising a first surface, an opposing second surface and at least one high aspect ratio feature shaped into at least one surface; heating the green featured ceramic part to form a debound featured ceramic part; and densifying the debound featured ceramic part via one of a pressureless sintering process or a hot-pressing process.

### CROSS-REFERENCE TO RELATED APPLICATIONS

This application claims the benefit of priority under 35 U.S.C. § 120 of U.S. Application Ser. No. 63/167,717, filed on Mar. 30, 2021, the content of which is relied upon and incorporated herein by reference in its entirety.

### FIELD OF THE DISCLOSURE

The disclosure relates to methods of fabricating of ceramic structures, and more particularly to methods of fabricating ceramic structures having profiled surfaces and more particularly to methods of fabrication of ceramic mirror blanks.

### BACKGROUND

Ceramics such as silicon carbide or boron carbide are desirable materials for forming complex parts with profiled shaped for various industries. SiC, for example, has relatively high elastic module, high thermal conductivity, useful in performing and controlling endothermic or exothermic reactions as well as good physical durability, thermal shock resistance and chemical corrosion resistance. These properties are useful, for example, in aerospace and defense applications requiring stiff, lightweight mirror blanks for high frequency mirror scanning and low weight airborne and space imaging systems. However, these properties, combined with high hardness and abrasiveness, also make the practical production of complex profiled ceramic structures challenging.

Accordingly, there is a need for improved methods of fabricating stiff, lightweight ceramic structures having profiled surfaces.

### SUMMARY OF THE DISCLOSURE

According to some aspects of the present disclosure, a method of forming a featured ceramic article, includes: forming a green pressed ceramic body comprising a first surface, an opposing second surface and at least one feature shaped into at least one surface, wherein forming the green pressed ceramic body comprises: placing a first mold having at least one feature within a cavity of a pressing die, pouring ceramic powder within the cavity wherein the ceramic powder at least completely covers the first mold, applying about 30 MPa to about 130 MPa of pressure to the ceramic powder within the cavity to form the green pressed body, and removing the mold and green pressed body from the cavity, and separating the first mold and the green pressed body; heating the green pressed body to form a debound featured ceramic part; and densifying the debound featured ceramic part via a hot-pressing process, wherein the hot-pressing process comprises: inserting the debound featured ceramic part into a hot-pressing die, pouring a first layer of fill material into the hot-pressing die, the first layer of fill material having compression characteristics during hot pressing that are within about 10% of the compression characteristics of the adjacent debound featured ceramic part, wherein the fill material completely fills the at least one features, applying a first pressure to the debound featured ceramic part in a direction perpendicular to the first surface, applying a second pressure to the debound featured ceramic part in a direction perpendicular to the second surface while applying the first pressure, heating the debound featured ceramic part while applying the first pressure and second pressure to compress the debound featured ceramic part in a direction of the thickness of the featured ceramic part, removing the sintered featured ceramic part from the hot-pressing die, and removing the fill material powder to expose the at least one features.

A method of forming a shaped ceramic article includes: forming, via a pressure casting process, a green ceramic body comprising a first surface, an opposing second surface and at least one feature shaped into at least one surface, wherein the pressure casting process comprises: pumping a ceramic solution comprising a liquid component and a solid component into a mold cavity comprising at least one featured surface, wherein the mold cavity is defined by a porous top surface wall, a porous bottom surface wall and porous sidewalls, and wherein the liquid component of the ceramic solution flows through the porous walls of the mold cavity and the solid component remains within the mold cavity to pressure cast the green featured ceramic body, removing the green ceramic body from the mold cavity, and heating the green ceramic body to form a debound featured ceramic part; densifyling the debound featured ceramic part via a hot-pressing process, wherein the hot-pressing process comprises: inserting the debound featured ceramic part into a hot-pressing die, pouring a first layer of fill material into the hot-pressing die, the fill material having compression characteristics during hot pressing within about 10% of the compression characteristics of the adjacent debound featured ceramic part, wherein the fill material fills the at least one features, applying a first pressure to the debound featured ceramic part in a direction perpendicular to the first surface, applying a second pressure to the debound featured ceramic part in a direction perpendicular to the second surface while applying the first pressure, heating the debound featured ceramic part while applying the first pressure and second pressure to compress the debound featured ceramic part in a direction of the thickness of the featured ceramic part, removing the sintered featured ceramic part from the hot-pressing die, and removing the fill material powder to expose the features of the ceramic part.

According to some additional aspects of the present disclosure a method of forming a shaped ceramic article includes: forming a green pressed ceramic body comprising a first surface, an opposing second surface and at least one feature shaped into at least one surface, wherein forming the green pressed ceramic body comprises: placing a first mold having at least feature within a cavity of a pressing die, pouring ceramic powder within the cavity wherein the ceramic powder at least completely covers the first mold, applying about 30 MPa to about 130 MPa of pressure to the ceramic powder within the cavity to form a green pressed body, and separating the first mold and the green pressed body; heating the green pressed body to form a debound featured ceramic part; and densifying the debound featured ceramic part via a pressureless sintering process, wherein the pressureless sintering process comprises heating the debound featured ceramic part at a temperature of about 2000 degrees Celsius to about 2400 degrees Celsius in an inert gas atmosphere.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A-11B is a perspective external view of an exemplary ceramic article with at least one featured surface, in accordance with some embodiments of the current disclosure;

FIG. 2A is a flowchart of an exemplary process for forming a featured ceramic article, in accordance with some embodiments of the current disclosure;

FIG. 2B is a flowchart of exemplary process for forming a green pressed ceramic body, in accordance with some embodiments of the current disclosure;

FIG. 2C is a flow chart flowchart of an exemplary process for densifying the debound featured ceramic part via a hot-pressing process, in accordance with some embodiments of the current disclosure;

FIG. 3A-3E, depict an exemplary cold pressing process flow for forming a green ceramic article in accordance with some embodiments of the current disclosure;

FIG. 4A-4B depict an exemplary process flow for preventing cracks from forming in the green pressed body from expansion of melting the mold in accordance with some embodiments of the current disclosure;

FIG. 5 depicts an alternative exemplary process for preventing cracks from forming in the green pressed body from the expansion of melting the mold in accordance with some embodiments of the current disclosure;

FIG. 6 depicts an exemplary debound ceramic part having at least one feature shaped into the first surface in accordance with some embodiments of the current disclosure;

FIG. 7A-7G depict an exemplary hot-pressing process flow for densifying the debound featured ceramic part in accordance with some embodiments of the current disclosure;

FIG. 8 depicts a pressure casting process for forming a green pressed ceramic article in accordance with some embodiments of the current disclosure;

FIG. 9 is a graph illustrating compression release curves useful in practicing the methods of the present disclosure; and

FIGS. 10-12 are graphs illustrating compression and/or release curves of candidate materials for a molds useful in practicing the methods of the present disclosure.

### DETAILED DESCRIPTION OF THE PREFERRED EMBODIMENTS

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

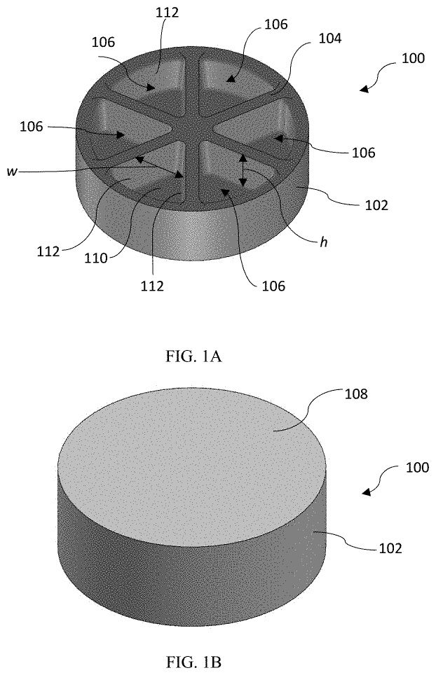

FIG. 1A-1B depicts an exemplary ceramic article 100 with at least one featured surface. The article 100 comprises a monolithic closed-porosity ceramic body 102 with a first surface 104 having a plurality of features 106 shaped into the first surface 104 of the body 102. The term “monolithic” is defined herein, refers to a ceramic structure, with one or more features therein, in which no (other than the feature(s)) inhomogeneities, openings, or interconnected porosities are present in the ceramic structure. “Monolithic” as used herein has the meaning provided above. However, Applicants reserve a right to otherwise define monolith if expressly so stated, such as in the claims, where monolithic may alternatively be defined as a body of sintered polycrystalline ceramic material with a continuous chain of grains ionically or covalently bonded to one another yet where the body may include internal passages and interstitial pores between grains, and optionally where most interstitial pores have a maximum crosswise dimension of less than one micron, such as less than 0.5 microns, and/or where the body is free of components (e.g. halves of the body) bonded to one another by Van der Waal forces. While the embodiments of FIG. 1A-1B depicts a body 102 having six features 106, the body 102 may have more, or less, features than shown in FIG. 1A. The plurality of features 106 may be distributed in any arbitrary pattern, where the goal is reducing weight by eliminating material that is not needed to allow the article to meet mechanical stiffness requirements. FIG. 1B depicts a second surface 108, opposing the first surface 104, of the body 102. In the embodiments depicted in FIG. 1B, the second surface 108 is a flat surface without any features formed therein. In some embodiments, features may also be formed in the second surface 108. In some embodiments, the second surface 108 may have a concave surface feature, a convex surface feature, or a parabolic profile.

According to further embodiments, the exemplary ceramic article 100 has a density of 90% to 99% of a theoretical maximum density of the chosen ceramic material, or preferably 92% to 97% of theoretical maximum density of the chosen ceramic material, or preferably 95% to 97% of theoretical maximum density of the chosen ceramic material. The theoretical maximum density (also known as maximum theoretical density, theoretical density, crystal density, or x-ray density) of a polycrystalline material, such as SiC, is the density of a perfect single crystal of the sintered material. Thus, the theoretical maximum density is the maximum attainable density for a given structural phase of the sintered material.

In an exemplary embodiment, the ceramic material is α-SiC with a hexagonal 6H structure. The theoretical maximum density of sintered SiC(6H) is 3.214 f 0.001 g/cm³. Munro, Ronald G., “Material Properties of a Sintered α-SiC,” Journal of Physical and Chemical Reference Data, 26, 1195 (1997). The ceramic material in other embodiments includes a different crystalline form of SiC or a different ceramic altogether. The theoretical maximum density of other crystalline forms of sintered SiC can differ from the theoretical maximum density of sintered SiC(6H), for example, within a range of 3.166 to 3.214 g/cm³. Similarly, the theoretical maximum density of other sintered ceramics also differs from that of sintered SiC(6H). As used herein, a “high density” ceramic body is a ceramic body in which the sintered ceramic material of the ceramic body has a density of at least 95% of the theoretical maximum density of the ceramic material.

The feature 106, according to some embodiments as depicted in FIG. 1A, comprises a depressed floor 110 and a plurality of sidewalls 112 joining the floor 108. The top of the sidewalls 112 have a height h above the depressed floor 110. The sidewalls 112 are separated by a width w measured perpendicular to the height h. Further, width w is measured at a position corresponding to one-half of the height h. The sidewalls 112 may also include a draft angle, such as 1-5°. In embodiments, the sidewalls 112 include fillets where the sidewalls 112 meet the depressed floor 110, where the fillet radius is, for example, 10% to 100% of the sidewall height h. In embodiments, fillets may also be provided where sidewalls 112 meet each other and the perimeter wall, where the fillets have a radius that is, for example, 1% to 30% the length of the radial sidewalls. In some embodiments, the feature may be a high aspect ratio feature where the ratio of the height (or depth) to the width of the feature is 2:1, or 4:1, or 8:1, or 12:1.

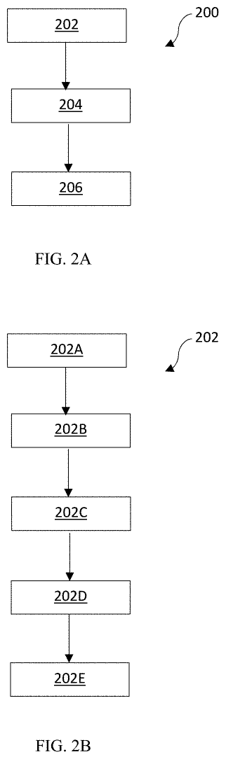

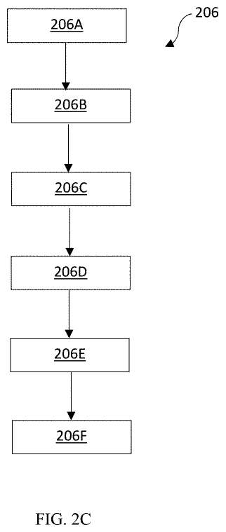

FIG. 2A depicts a flowchart of an exemplary process 200 for forming a featured ceramic article. In some embodiments, the process 200 begins at step 202 by forming a green pressed ceramic body having a first surface, an opposing second surface and at least one feature shaped into at least one surface of the body. Next, at step 204, the green pressed body is heated to form a debound featured ceramic part. Next at step 206, the debound featured ceramic part is densified via a hot-pressing process or pressureless sintering process.

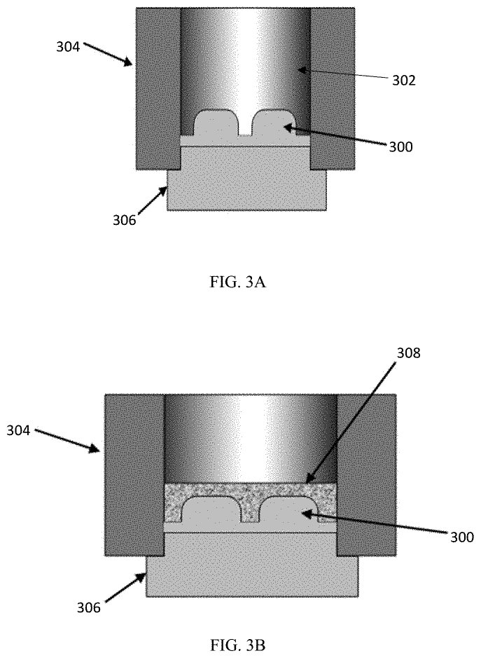

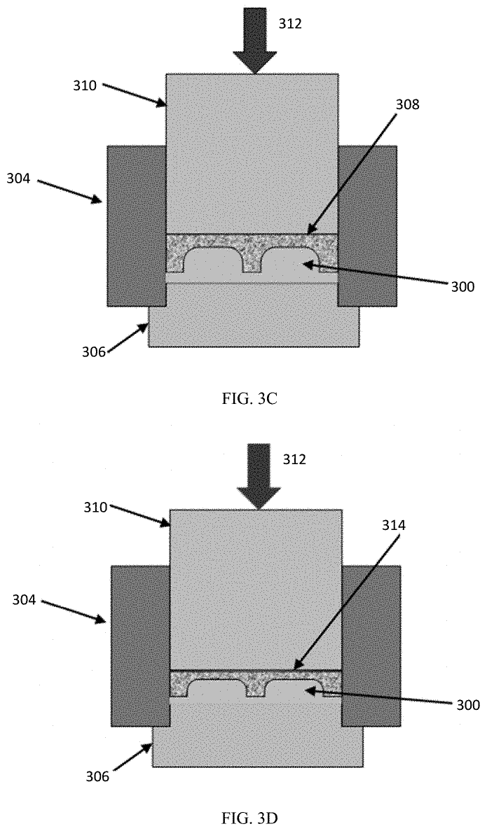

In some embodiments, the green pressed ceramic article is formed via a cold pressing process. FIG. 2B depicts an exemplary flowchart of process step 202 for forming a green pressed ceramic body. FIGS. 3A-3E, depict an exemplary cold pressing process flow for forming a green ceramic article. Process 202 begins at step 202A where, as depicted in FIG. 3A, a first mold 300 for forming features on the exterior of the ceramic article is placed in a cavity 302 of a pressing die 304. The pressing die 304 is closed with a plug 306. Next at step 202B, as depicted in FIG. 3B, a ceramic powder 308 is poured over the first mold 300 to at least completely cover the first mold 300. The amount of ceramic powder poured into the cavity 302 can vary based on the desired thickness of the target ceramic article. In some embodiments, the ceramic powder comprises ceramic particles, for example of boron carbide (B₄C), silicon carbide (SiC), alumina (Al₂O₃), or zirconia (ZrO₂), coated with an organic binder material, for example phenolic resin or polyvinyl alcohol (PVA). Next at step 202C, as depicted in FIG. 3C a piston or ram 310 is inserted in the cavity 302 and a uniaxial force (AF) 312 is applied from above to compress the ceramic powder 308 with the mold 300 inside to form a pressed body. A reaction force or equal counteracting force AF (not shown) is supplied at the plug 306 during this step. In some embodiments, a pressure of about 30 MPa to about 130 MPa is applied to the ceramic powder 308 to form a green pressed body 314. In some embodiments, a pressure of about 30 MPa to about 50 MPa is applied to the ceramic powder 308 to form a green pressed body 314. In some embodiments, a pressure of about 70 MPa to about 130 MPa is applied to the ceramic powder 308 to form a green pressed body 314. In some embodiments, a second mold (not shown) may be inserted into the cavity 302 prior to applying a force to compress the ceramic powder, thereby forming features in both surfaces of the ceramic article. Next at step 202D, as depicted in FIG. 3E, the mold 300 and the green pressed body 314 are removed from the cavity 302.

Next at step 202E, the mold 300 and the green pressed body 314 are separated. In some embodiments, prior to heating, at least a portion of the mold 300 can be removed from the cavity via, for example, machining. The green pressed body 314 is heated, preferably at a relatively high rate, such that the mold 300 is melted and removed from the green pressed body 314 by flowing out of the green pressed body 314, and/or by being blown and/or sucked out in addition. In an alternative embodiment, this step 202E can be divided into two parts, where first the green pressed body 314 is heated, and then next, separately, the mold is allowed to flow out of the body. The heating may be under partial vacuum, if desired. During heating the mold 300 will expand as it melts. The resulting expansion force can produce cracks in the surrounding green pressed body 314. In one embodiment, an external force can be applied to one or more outer surfaces of the green pressed body 314 to prevent cracking.

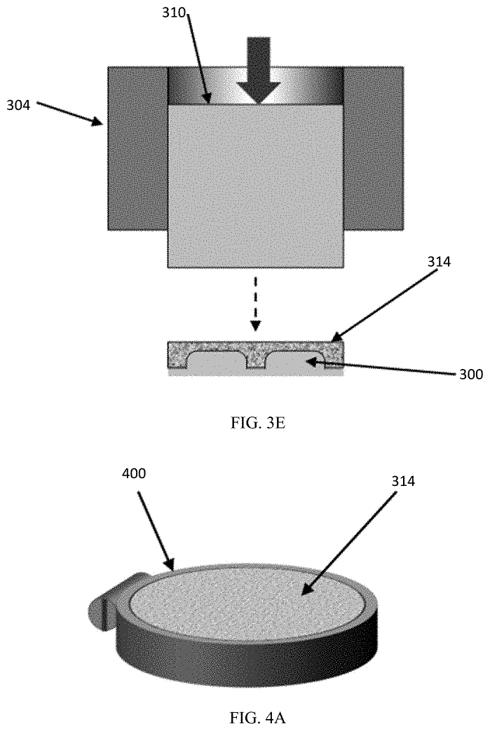

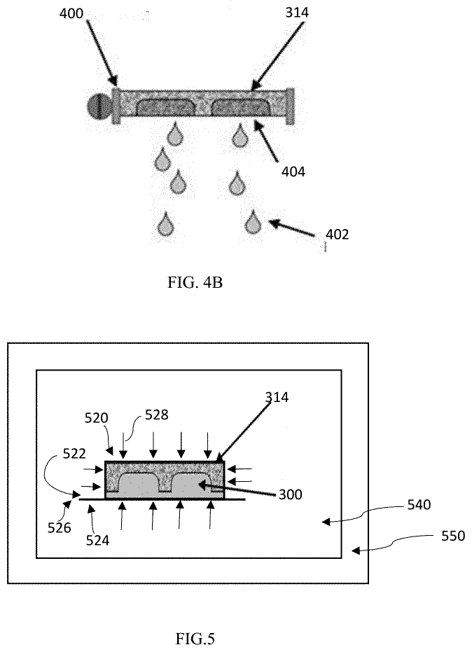

FIGS. 4A and 4B depict one embodiment of preventing cracks from forming in the green pressed body 314 from expansion of melting mold material. In some embodiments, the mold is heated to a temperature of about 60 degrees Celsius to about 130 degrees Celsius to melt the mold 300. As depicted in FIG. 4A-4B, a clamp 400 is placed around the perimeter of the green pressed body 314. The clamp provides an external force opposing the expansion force of the melting max. The melted mold 402 flows out of the cavities 404 in the green pressed body 314.

In an alternative embodiment, green pressed body 314 is sealed within a fluid-tight bag 520. As seen in FIG. 5, the bag 520 can include a top layer 522 and a bottom layer 524 sealed together at a seal region 526, such as by pinching together and heating top and bottom layers 522, 524 which can be formed of polymer. Multiple rows of thermally produced seals can be used in the seal region 526 if desired. Vacuum sealing can be used and is preferred but not required-successful tests have been performed with and without vacuum sealing. The bag is fluid-tight to the fluid 540 in the chamber 550, which can be, for example, water.

Further in FIG. 5, a press chamber 550 holds a fluid which is desirably preheated to a target temperature for melting the mold (for example, to 50° C. for a wax-based mold). The bag 520 with the green pressed body 314 sealed inside is then lowered into the isostatic press chamber fluid 540. The isostatic press chamber 550 is closed and sealed and pressure is applied to the chamber fluid (e.g., in the range of 100-600 PSI), producing essentially isostatic pressure on all surfaces of the body 314. The pressure and temperature are maintained for a period of time, such as 90 minutes, to melt the material of the mold 300.

As the green pressed body 314 is heated by the warm fluid, the mold 300 is also heated, and the mold material begins expanding, softening, and melting. The expansion produces an outward force on the interior walls of the passages within the body 314. The outward force is counteracted and/or balanced, at least in part, by the isostatic pressing force, represented by the arrows 528, applied to the exterior surface of the body 314 through the bag 520. In some embodiments, the green pressed body 314 can be placed on a metal support or carrier prior to being sealed in a fluid-tight bag 520, so that the mold 300 faces the metal support, and both parts are sealed within the bag. The support helps retain the shape of the mold 300 and prevents distortion and collapse of cavities during heating and chamber 550 pressurization

After the time period to melt the material of the mold 300 is ended, the pressure inside the chamber 550 is reduced to atmospheric pressure, the chamber is opened and the bag 520 and body 314 are removed, and the bag 520 is removed from the body 314. The body is preferably kept sufficiently warm (for example, at 50° C. or greater) to prevent re-solidification of the mold material, until any remaining mold material is completely removed, such as by heating the body 314 in an oven (for example, at 175° C., in air). While heating, the body can be oriented to allow the mold material to drain out of the body 314.

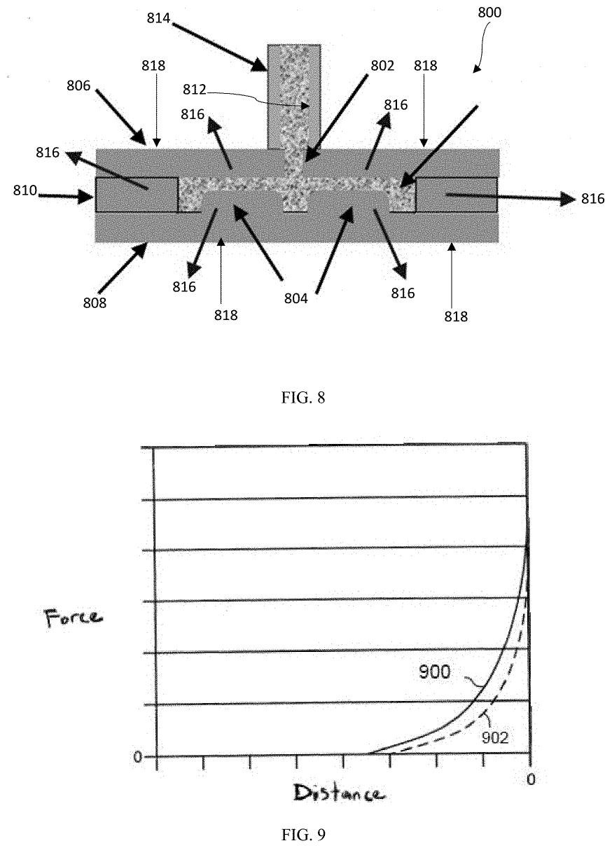

In an alternative embodiment, the green pressed ceramic article is formed via a pressure casting process. FIG. 8 depicts an exemplary pressure casting mold 800 for forming a green ceramic article. The pressure casting process comprises pumping a ceramic solution 812, comprising a liquid component and a solid component, into a mold cavity 802. In some embodiments, the ceramic solution comprises 25 vol. % solids and 75 vol. % water (10% to 50 Vol %). In some embodiments, the ceramic solution comprises 25 vol. % solids and 75 vol. % water (10% to 40 Vol %). In some embodiments, the ceramic solution comprises 25 vol. % solids and 75 vol. % water (10% to 30 Vol %). In some embodiments, the solid component comprises 95 wt % to 99 wt % boron carbide and 1 wt % to 5 wt % amorphous boron.

The mold cavity 802 is defined by a porous top surface wall 806, a porous bottom surface wall 808 and porous sidewalls 810. The pressurized ceramic solution 800 is pumped into the mold cavity 802 via an inlet tube 814 fluidly connected to the mold cavity 802 via an opening in the top surface wall 806. Pressure 818 is applied to the casting mold 800, for example via clamps at the outer top and bottom surfaces of the casting mold 800. The liquid component 816 of the ceramic solution flows through the porous walls 806, 808, 810 of the mold cavity 802 and the solid component remains within the mold cavity 802 and densifies as the liquid component is removed. The mold cavity 802 comprises at least one featured surface 804. In the embodiment depicted in FIG. 8, the featured surface 804 is formed in the bottom surface wall 808. Alternatively, or in combination, the featured surface may be formed in the top surface wall 806. After the mold cavity 802 is filled, the green ceramic body is removed from the mold cavity. Following the pressure casting process as described above, the green ceramic body 314 is debound to remove the polymer binder material from the ceramic particles as described in step 204 below.

Referring to FIG. 2A, after removal of the mold 300, at step 204 the green pressed body 314 is debound to remove the polymer binder material from the ceramic particles. In some embodiments, the green pressed body 314 is heated at a temperature of about 500 degrees Celsius to about 600 degrees Celsius in a nitrogen atmosphere.

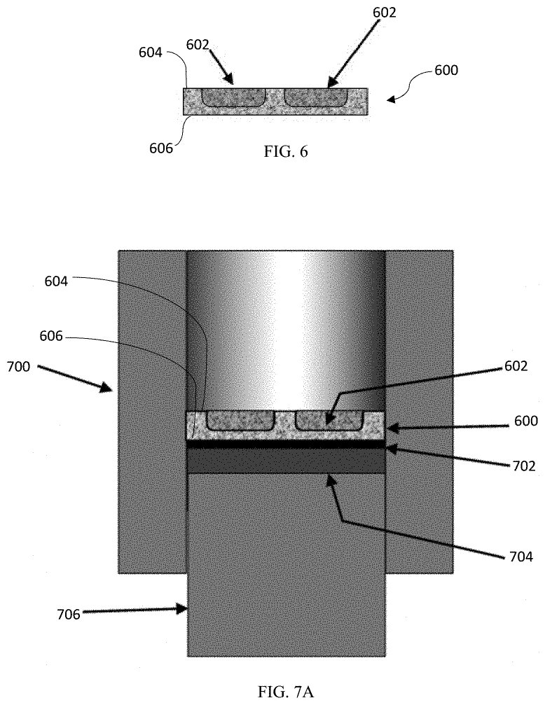

Next at step 206, the debound featured ceramic part is densified via a hot-pressing process or pressureless sintering process. Sintering is a process wherein the debound featured ceramic part is subjected to high temperatures and selected atmospheres (e.g. a reducing atmosphere) to cause the debound featured ceramic part to become a coherent mass by heating. In one embodiment, the pressureless sintering process heats the debound featured ceramic part at about 2000 degrees Celsius to about 2400 degrees Celsius, preferably about 2100 degrees Celsius to about 2300 degrees Celsius, more preferably about 2150 degrees Celsius to about 2250 degrees Celsius. Following pressureless sintering, an exemplary ceramic article of boron carbide (B₄C) has a density of 92% to 100%, or in embodiments 92% to 98%, or in embodiments 94% to 98% or in embodiments 92% to 96%, of a theoretical maximum density of the chosen ceramic material and an exemplary ceramic article of silicon carbide (SiC) has a density of 92% to 100%, or in embodiments 92% to 96%, or in embodiments 92% to 98%, or in embodiments 96% to 100%, of a theoretical maximum density of the chosen ceramic material. FIG. 6 depicts an exemplary debound ceramic part 600 having at least one feature 602 shaped into the first surface 604. The embodiment depicted in FIG. 6 has a second surface 606 that is flat (i.e. featureless). In some embodiments, the second surface is concave, or convex.

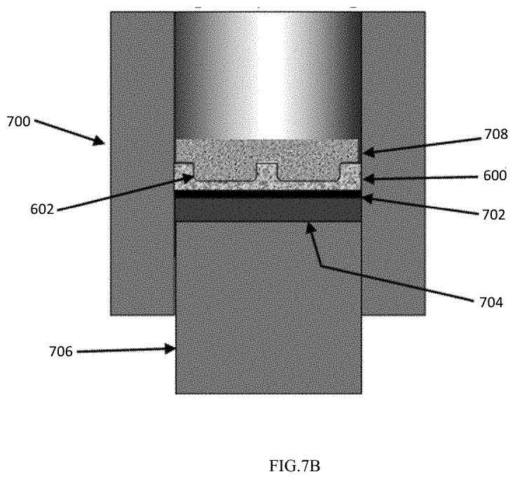

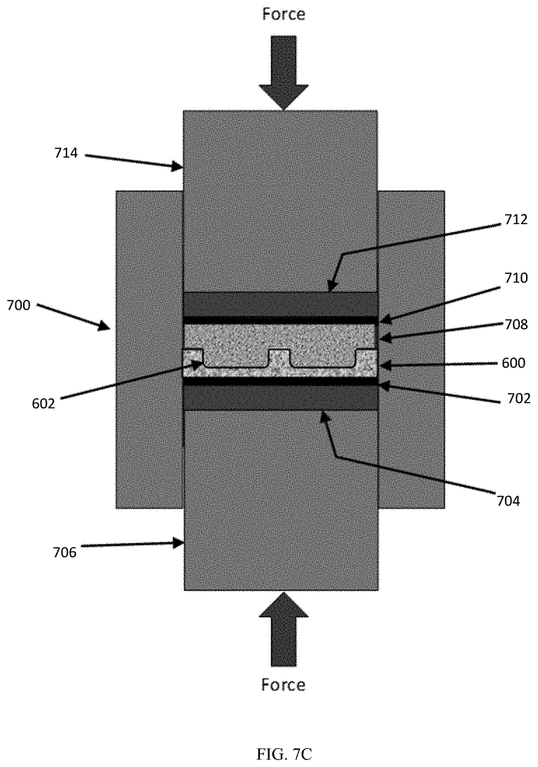

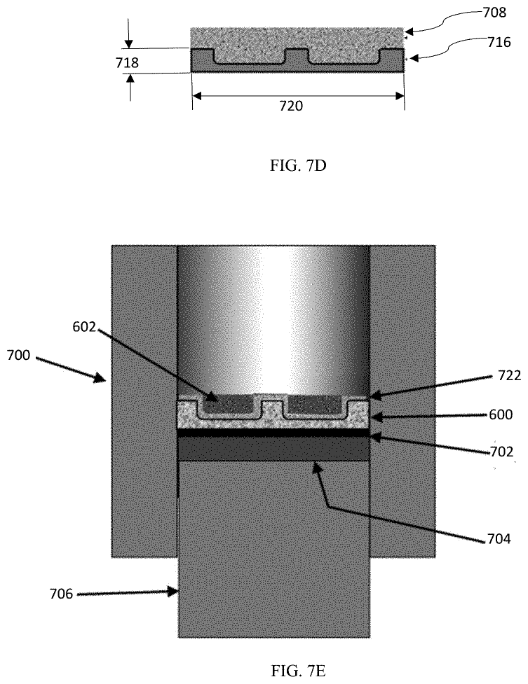

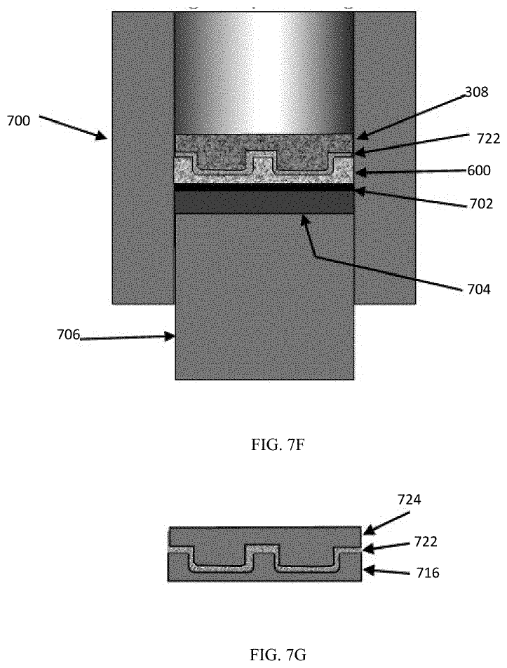

FIG. 2C depicts an exemplary flowchart of process step 206 for densifying the debound featured ceramic part via a hot-pressing process. Densifying is a process wherein the voids between granules of the ceramic part are reduced to form an article having an evenly (i.e uniformly) densified volume of material. Following the hot-pressing process, an exemplary ceramic article of boron carbide (B₄C) has a density of greater than 99% of a theoretical maximum density of the chosen ceramic material and an exemplary ceramic article of silicon carbide (SiC) has a density of greater than 99.5% of a theoretical maximum density of the chosen ceramic material. FIGS. 7A-7D, depict an exemplary hot-pressing process flow for densifying the debound featured ceramic part. Process 206 begins at step 206A where, as depicted in FIG. 7A, the debound featured ceramic part 600 is inserted into a hot-pressing die 700. In the embodiment depicted in FIG. 7A, the debound part rests 600 on a grafoil release sheet 702 and a graphite spacer 704 that are supported by the lower graphite ram 706. FIG. 7A shows the debound part 600 positioned in the graphite die with its flat surface (second surface 606) oriented downward (resting on the grafoil release sheet 702) and its profiled surface (first surface 604) facing upward. Next at step 206B where, as depicted in FIG. 7B, a first layer of fill material 708 is poured into the hot-pressing die. During the hot-pressing process, both the debound part 600 and the fill material 708 become compressed. Accordingly, the compression characteristic (i.e. the amount of compression imparted onto the material by the same amount of force) of the fill material 708 during pressing is selected to be closely matched (e.g. within about 10%) to the compression characteristic of the debound part 600. As a result, the debound part 600 can be pressed without any cracks or significant variations in density across its profiled surface. In some embodiments, the fill material has compression characteristics during hot pressing that are within about 10% of the compression characteristics of the adjacent debound part 600. In some embodiments, the first layer of fill material is a graphite powder. In some embodiments, an exemplary graphite powder having suitable compression characteristics is a graphite powder having an average particle diameter d50 of 150 μm. The d50 is the diameter where 50% by weight of the component is in particles having diameters equal to or lower than the d50, while just under 50% of the weight of the component is present in particles having a diameter greater than the d50. In some embodiments, the fill material completely fills the at least one features 602, and in some embodiments as depicted in FIG. 7B can completely cover the debound part 600.

Next, at step 206C, 206D, and 206E where, as depicted in FIG. 7C, a first pressure is applied to the debound part 600 in a direction perpendicular to the first surface (206C), a second pressure is applied to the debound featured ceramic part in a direction perpendicular to the second surface while applying the first pressure (206D), and the debound part is heated while applying the first pressure and second pressure (206E) to compress the debound featured ceramic part in a direction of the thickness of the featured ceramic part. A second grafoil release sheet 710 and a second graphite spacer 712 are placed on top of the graphite powder 708. The upper graphite ram 714 is inserted into the die to apply a first pressure to the debound part 600 in a direction perpendicular to the first surface 604 while the lower graphite ram 706 applies a second pressure to the debound part 600 in a direction perpendicular to the second surface 606. The die is heated while uniaxial compression is applied to the debound part 600.

Next, at step 206F where, as depicted in FIG. 7D, the sintered ceramic part 716 with packed fill material 708 on its profiled surface (first surface 604) is removed from the hot-pressing die 700. After hot pressing, the sintered ceramic part 716 is compressed in its thickness direction 718, while its diameter 720 remains relatively unchanged from its original diameter, which is closely matched to the inside diameter of the graphite die. Next, at step 206F the fill material powder is removed via mechanical processing, such as scraping or sand blasting, to expose the at least one features 602.

In an alternative hot-pressing embodiment, at step 206B and as depicted in FIG. 7E and FIG. 7F, the fill material is mixed with a liquid binder, such as a polymer binder (e.g. methylcellulose in water) or an adhesive (e.g., water-based glue) to form a release layer 722. A thin layer of the release layer 722 is applied, for example via spray coating, brushing, or similar application processes, in uniform thickness over the first surface 604 of the debound part 600. The thickness of the release layer is sufficient to cover the first surface 604 of the debound part 600 but does not fill the at least one features 602. In some embodiments, the release layer 722 has a thickness of about 1 mm to about 2 mm. Following application of the release layer, the at least one features 602 are filled with a ceramic powder 308 that is used to form the green pressed body 314. Next, step 206C, 206D, and 206E are applied as described above, resulting in densification of both the debound part 600 and the ceramic powder 308. The ceramic powder 308 forms a hot-pressed sacrificial form 724. After hot pressing, and as depicted in FIG. 7G, both the sintered ceramic part 716 and the sacrificial form 724 are ejected from the die 700 while still joined together by the release layer 722. The sintered ceramic part 716 and the sacrificial form 724 are easily separated, since the release layer 722 does not sinter during hot pressing. The release layer 722 can be removed from the hot-pressed part by mechanical abrasion (e.g., brushing or sand blasting).

The material of the mold can be an organic material such as an organic thermoplastic. The mold material may include organic or inorganic particles suspended or otherwise distributed within the material as one way of decreasing expansion during heating/melting. As mentioned, the material of the passage mold is desirably a relatively incompressible material-specifically a material with low rebound after compression relative to the rebound of the pressed ceramic powder after compression. Mold materials loaded with particles can exhibit lower rebound after compression. Mold materials which are capable of some degree of non-clastic deformation under compression also naturally tend to have low rebound (e.g., materials with high loss modulus). Polymer substances with little or no cross-linking, for example, and/or materials with some local hardness or brittleness which enables localized fracturing or micro-fracturing upon compression can exhibit low rebound. Useful mold materials can include waxes with suspended particles such as carbon and/or inorganic particles, rosin containing waxes, high modulus brittle thermoplastics, and even organic solids suspended in organic fats such as cocoa powder in cocoa butter—or combinations of these. Low melting point metal alloys also may be useful as mold materials, particularly alloys having low or no expansion on melting.

As the mold is heated to be melted and removed, the mold material can potentially expand more than is desirable before sufficiently low viscosity is reached for the mold material to flow away and relieve the pressure of expansion. If the pressure generated during mold removal is excessive, the passage being formed may be damaged. As an additional alternative embodiment addressing this potential issue, a mold may be used which has an outer layer of lower melting material having a melting point than the rest or inner portion of the mold. By selecting a lower melting material having a sufficiently lower melting point then the remainder of the mold, when the mold is heated to remove the mold, the outer layer can transition to low viscosity before the mold as a whole has expanded significantly, and the outer layer can then flow away as the remainder of the mold is further heated and expands then melts, relieving pressure that may otherwise be undesirably high. Melting point separation between the low melting material melting point and the melting of the remainder of the mold is desirably at least 5° C., or even 20° C. or even 40° C. but generally not more than 80° C. The outer layer can be formed by a second molding or by dipping or the like.

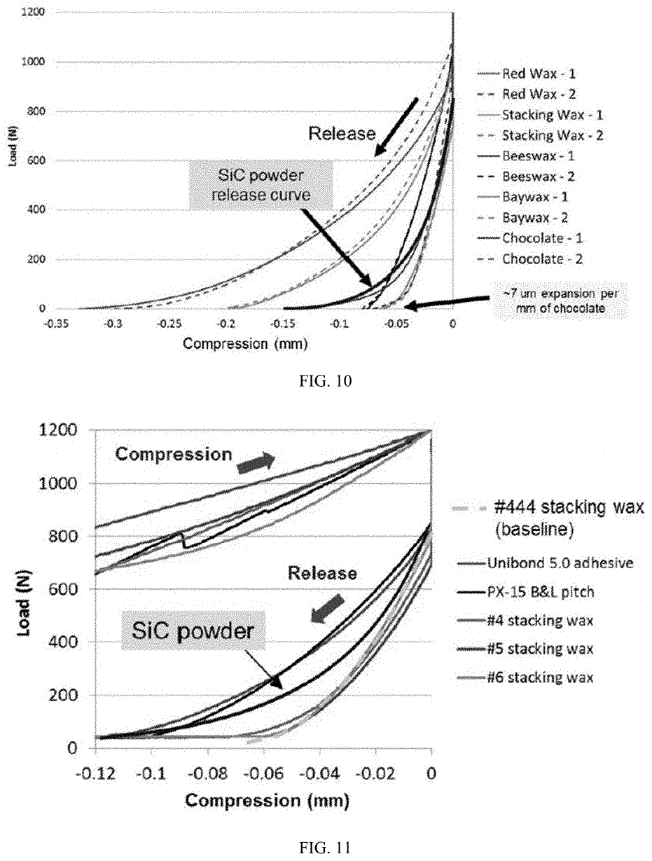

FIG. 9 is a graph illustrating compression release curves useful in practicing the methods of the present disclosure. The curves in the graph show a desirable relationship between a first stability characteristic of SiC powder and a second stability characteristic of the mold 300. In practice, the compression release curves can be generated experimentally by pressing a respective sample of a ceramic powder or a mold with a press to a measured maximum force and then reducing the displacement of the press while continuing to measure the reaction force generated by the sample. Some such experiments are described later with reference to FIGS. 10-12. As a result of the first stability characteristic, the SiC powder expands or rebounds from a maximum compressed state over a displacement that follows the compression release curve 900 of FIG. 9 to define a first release displacement. Similarly, as a result of the second stability characteristic, the mold 300 expands or rebounds from a maximum compressed state over a displacement that follows the compression release curve 902 of FIG. 9 to define a second release displacement. The compression release curves 900 and 902 are graphed in units of distance (x axis) versus force (y axis).

The curvature of the force-displacement curve to the left as it drops is an indication of how much stored energy is released from the samples during the release phase. To simplify comparison of the samples, the force-displacement curve for each sample are shifted so that the release phase curves are aligned at initial release. The leftward trend in the curves corresponds to the upward motion of the press and the concurrent reduction in reaction force on the press. It is preferable that the first release displacement of the SiC powder material along the compression release curve 900 is greater than the second release displacement of the material of the mold 300 along the compression release curve 902. The first release displacement is preferably greater than the second release displacement along an entirety of the compression release curves 900 and 902. Such a relationship between the first and second release displacements is beneficial to prevent discontinuities, such as cracks, in the pressed body after pressing, during heating, or after pressing and during heating.

The compression displacement along the compression curve, not shown, is not particularly significant. But using a relatively incompressible mold material such that the SiC release displacement is greater than the mold release displacement helps maintain the structural integrity of the pressed body during steps after pressing. Further, to achieve the smooth internal passage walls, coated SiC powder with generally smaller particle sizes is preferred, as are mold materials having generally higher hardness.

In further embodiments, the second release displacement of the material of the mold can be greater than the first release displacement of the SiC powder along portions or an entirety of the compression release curves 900 and 902. With this relationship between the first and second release displacements, the material of the mold can expand more than the SiC powder after pressing such that the mold exerts a force on the pressed SiC body surrounding it. A tensile strain can be produced in the SiC powder when the expansion of the mold 300 is greater than the expansion of the SiC powder. If the tensile strain exceeds the ultimate tensile strength of the green pressed SiC powder, cracks can appear in the SiC powder adjacent to the mold 300.

To address this undesirable result, the first stability characteristic of the SiC powder can further include a binder strength that is configured to counteract a release force of the mold after pressing. The binder-coated SiC powder includes particles of α-SiC with a hexagonal 6H structure, which are surrounded by a binder. The binder strength of a binder relates to the type of binder and the amount of binder. A non-exhaustive list of binders that can be used includes phenolic resin, phenol, polyvinyl alcohol (PVA), formaldehyde, coal tar pitch, polymethylmethacrylate, methyl methacrylate, wax, polyethylene glycol, acetic acid, ethenyl ester, carbon black, and triethanolamine. In one embodiment, the SiC(6H) particles are coated with a phenolic resin binder. The amount of binder is low enough to achieve the high density, closed-porosity ceramic body after sintering.

FIGS. 10-12 are graphs of the experimental determination of compression and/or release curves of various materials. Tests were carried out to characterize the elastic and loss moduli of various materials using an Instron measurement system. The Instron was configured to apply a known compressive displacement to a sample material held in a die, and then measure the reaction force generated by the sample. The resulting force-displacement relationship was assessed as each sample was controllably compressed (compression phase) and then controllably released from compression (release phase). The Instron measurement was conducted under force conditions configured to mimic the forces experienced by larger SiC fluidic devices during pressing. Since the maximum force that the Instron could produce and that its load cell could sustain was limited to 1200 N, material samples were prepared using a 0.75″ diameter die. Several different wax samples were prepared that were nominally 8 mm thick and 0.75″ diameter, including red wax, stacking wax (Universal Photonics #444), beeswax, bay wax, and Ghirardelli 100% cacao chocolate. Each sample was placed in a 0.75″ diameter die and compressed by the Instron at a fixed rate with compression terminated when the reaction force generated by the sample equaled 1200 N. After compression to a maximum force of 1200 N, the displacement was reduced while continuing to measure the reaction force generated by the sample.

FIG. 10 is a graph of the force-displacement curves for these noted samples. To simplify comparison of the various samples, the force-displacement curve for each sample was shifted so that all release phase curves line up with each other at the moment of initial release. For each sample as the displacement was reduced the reaction force dropped dramatically, but not instantaneously to zero. The curvature of the force-displacement curve to the left as it drops is an indication of how much stored energy is released from the sample during the release phase. The negative values of compression correspond to upward motion of the piston. The plot shows how different samples respond very differently during the release phase. Some samples, such as the red wax and bay wax, provide reaction forces over large displacement distances during the release phase, while others, such as chocolate and stacking wax, rapidly reduce their reaction force with displacement.

The area under the release phase force-displacement curves provides an indication of how much stored energy is released by the sample during the release phase. The point at which the force-displacement curve reaches the horizontal Load=0 N line provides an indication of the spring-back provided by the sample. For example, the spring-back of the chocolate and stacking wax samples was around 0.07 mm. Since the samples were 10-12 mm thick, this corresponds to a spring-back of around 7 um per mm of sample thickness.

Crack formation is also a function of the spring-back expansion of SiC powder. Measurements of reaction force vs. compression displacement for SiC powder samples during release phase were also taken. In the experiment, it was determined that force-displacement curve meets the Load=0 N line at a compression of about −0.13 mm. Since the samples were 10 mm thick, this corresponds to a spring-back of around 13 um per mm of sample thickness. The force-displacement curve of the SiC powder sample is plotted over the force-displacement curves of the various material samples in the graph of FIG. 10.

FIG. 11 is a graph of the force-displacement curves for different types of stacking waxes. One objective of this additional study was to identify hard waxes (for smooth internal channel sidewalls) that can be pressed without cracking the surrounding SiC powder. The waxes were characterized on the Instron following the approach described above with reference to FIG. 10. FIG. 11 depicts the force-displacement curves during both the compression and release phases. Samples with steep slopes during the compression phase are harder and expected to provide smooth internal channel sidewall surfaces. The force-displacement curves were shifted left so that all curves overlap on initiation of the release phase. All samples except Unibond 5.0 adhesive and PX-15 B&L pitch have force-displacement curves that fall well under the SiC powder force displacement curve.

In some embodiments, the material of the mold 300 has the following properties. Firstly, the mold material has a high loss modulus (G″) so that instead of storing energy like a rigid spring-like body, the energy is lost through physical reorganization of the body. Many high loss modulus materials have liquid-like properties that allow them to dissipate energy through reorganization. When the material is physically constrained so that bulk flow is not possible, high loss modulus materials dissipate energy through molecular-scale reorganization and heat generation. Secondly, mold material has an elastic (or storage) modulus (G′) that is just low enough to prevent excessive spring-back and cracking after pressing. If the mold material satisfies the elastic modulus G′ preference, it is preferable that the mold material also has a high hardness to enable formation of smooth sidewalls after pressing, which tends to directly correlate with an elastic modulus G′ that is as high as possible High elastic modulus (e.g., hard) materials generate smooth sidewalls by preventing SiC granule penetration during pressing.

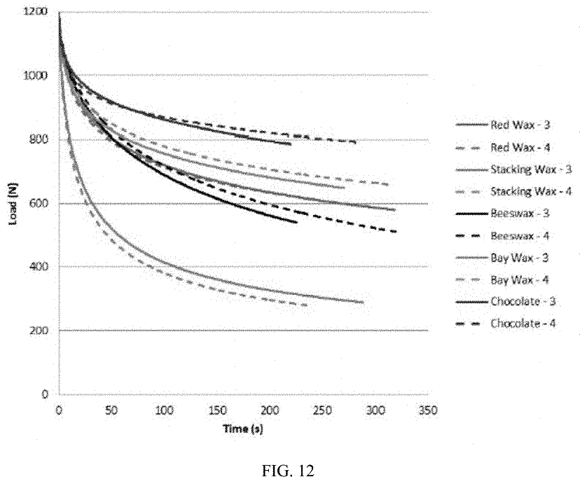

FIG. 12 is a graph illustrating the influence of a displacement hold at maximum displacement. Instron characterization of wax sample properties can include a displacement hold at maximum displacement. Measurements show that in this constant displacement configuration the sample reaction force drops rapidly over time. This is an indication that stored energy in the sample is being lost. FIG. 12 provides force-time curves during a hold at constant displacement, showing how the rate of reaction force reduction varies dramatically by sample.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A method of forming a featured ceramic article, the method comprising:
forming a green pressed ceramic body comprising a first surface, an opposing second surface and at least one feature shaped into at least one surface, wherein forming the green pressed ceramic body comprises:
placing a first wax mold having at least one feature within a cavity of a pressing die,
pouring ceramic powder within the cavity wherein the ceramic powder at least completely covers the first wax mold,
applying about 30 MPa to about 130 MPa of pressure to the ceramic powder within the cavity to form the green pressed body, and
removing the wax mold and green pressed body from the cavity, and
separating the first wax mold and the green pressed body;
heating the green pressed body to form a debound featured ceramic part; and
densifying the debound featured ceramic part via a hot-pressing process, wherein the hot-pressing process comprises:
inserting the debound featured ceramic part into a hot-pressing die,
pouring a first layer of fill material into the hot-pressing die, the first layer of fill material having compression characteristics during hot pressing that are within about 10% of the compression characteristics of the adjacent debound featured ceramic part, wherein the fill material completely fills the at least one features,
applying a first pressure to the debound featured ceramic part in a direction perpendicular to the first surface,
applying a second pressure to the debound featured ceramic part in a direction perpendicular to the second surface while applying the first pressure,
heating the debound featured ceramic part while applying the first pressure and second pressure to compress the debound featured ceramic part in a direction of the thickness of the featured ceramic part,
removing the sintered featured ceramic part from the hot-pressing die, and
removing the fill material powder to expose the at least one features.

2. The method of claim 1, further comprising: placing a second wax mold having at least one feature atop the ceramic powder within the cavity of the pressing die to form a green pressed body having the at least one feature on the first surface and at least one feature on the second surface.

3. The method of claim 2, wherein the hot-pressing process further comprises:
pouring a second layer of fill material into the hot-pressing die, prior to inserting the debound featured ceramic part into a hot-pressing die the second layer of fill material having compression characteristics during hot pressing that are within about 10% of the compression characteristics of the adjacent debound featured ceramic part.

4. The method of claim 1, wherein the hot-pressing process further comprises:
depositing a release layer onto the first surface of the debound featured ceramic part, wherein the release layer comprises a liquid binder and a fill material, after inserting the debound featured ceramic part into a hot-pressing die.

5. The method of claim 4, wherein the release layer has a thickness of about 1 mm to 2 mm

6. The method of claim 4, wherein the fill material is the ceramic powder.

7. The method of claim 1, wherein separating the first wax mold and the green pressed body comprises:
heating the green pressed body to a temperature of about 60 degrees Celsius to about 130 degrees Celsius to melt the wax mold; and applying an external pressure to at least one external surface of the green pressed body during heating to prevent crack formation.

8. A method of forming a shaped ceramic article, the method comprising:
forming, via a pressure casting process, a green ceramic body comprising a first surface, an opposing second surface and at least one feature shaped into at least one surface, wherein the pressure casting process comprises:
pumping a ceramic solution comprising a liquid component and a solid component into a mold cavity comprising at least one featured surface, wherein the mold cavity is defined by a porous top surface wall, a porous bottom surface wall and porous sidewalls, and wherein the liquid component of the ceramic solution flows through the porous walls of the mold cavity and the solid component remains within the mold cavity to pressure cast the green featured ceramic body,
removing the green ceramic body from the mold cavity, and
heating the green ceramic body to form a debound featured ceramic part;
densifying the debound featured ceramic part via a hot-pressing process, wherein the hot-pressing process comprises:
inserting the debound featured ceramic part into a hot-pressing die,
pouring a first layer of fill material into the hot-pressing die, the fill material having compression characteristics during hot pressing within about 10% of the compression characteristics of the adjacent debound featured ceramic part, wherein the fill material fills the at least one features,
applying a first pressure to the debound featured ceramic part in a direction perpendicular to the first surface,
applying a second pressure to the debound featured ceramic part in a direction perpendicular to the second surface while applying the first pressure,
heating the debound featured ceramic part while applying the first pressure and second pressure to compress the debound featured ceramic part in a direction of the thickness of the featured ceramic part,
removing the sintered featured ceramic part from the hot-pressing die, and
removing the fill material powder to expose the features of the ceramic part.

9. The method of claim 8, wherein the mold cavity comprises a first featured surface and an opposing second featured surface.

10. The method of claim 8, wherein the hot-pressing process further comprises:
depositing a release layer onto the first surface of the debound featured ceramic part, wherein the release layer comprises a liquid binder and a fill material, prior to pouring a first layer of fill material into the hot-pressing die.

11. The method of claim 10, wherein the release layer has a thickness of about 1 mm to 2 mm.

12. The method of claim 8, wherein separating the first wax mold and the green ceramic body comprises: heating the green body to a temperature of about 60 degrees Celsius to about 130 degrees Celsius to melt the wax mold; and applying an external pressure to at least one external surface of the green pressed body during heating to prevent crack formation.

13. A method of forming a shaped ceramic article, the method comprising:
forming a green pressed ceramic body comprising a first surface, an opposing second surface and at least one feature shaped into at least one surface, wherein forming the green pressed ceramic body comprises:
placing a first wax mold having at least feature within a cavity of a pressing die,
pouring ceramic powder within the cavity wherein the ceramic powder at least completely covers the first wax mold,
applying about 30 MPa to about 130 MPa of pressure to the ceramic powder within the cavity to form a green pressed body, and
separating the first wax mold and the green pressed body:
heating the green pressed body to form a debound featured ceramic part; and
densifying the debound featured ceramic part via a pressureless sintering process, wherein the pressureless sintering process comprises heating the debound featured ceramic part at a temperature of about 2000 degrees Celsius to about 2400 degrees Celsius in an inert gas atmosphere.

14. The method of claim 12, further comprising: placing a second wax mold having at least one feature atop the ceramic powder within the cavity of the pressing die to form a green pressed body having the at least one feature on the first surface and at least one feature on the second surface.

15. The method of claim 12, wherein the hot-pressing process further comprises:
pouring a second layer of fill material into the hot-pressing die, prior to inserting the debound featured ceramic part into a hot-pressing die the second layer of fill material having compression characteristics during hot pressing that are within about 10% of the compression characteristics of the adjacent debound featured ceramic part.
